(19) United States
(12) Patent Application Publication
(10) Pub. No.: US 2014/0261030 A1
(43) Pub. Date: Sep. 18, 2014

(54) SYSTEMS FOR APPLYING DAMPENING FLUID TO AN IMAGING MEMBER FOR INK-BASED DIGITAL PRINTING

(71) Applicant: XEROX CORPORATION, Norwalk, CT (US)

(72) Inventors: Chu-heng LIU, Penfield, NY (US); Richard W. SEYFRIED, Williamson, NY (US); Jack LESTRANGE, Macedon, NY (US); Daniel M. BRAY, Rochester, NY (US)

(73) Assignee: XEROX CORPORATION, Norwalk, CT (US)

(21) Appl. No.: 13/836,164

(22) Filed: Mar. 15, 2013

(51) Int. Cl. B41F 7/24

(52) U.S. Cl. CPC B41F 7/24
USPC 101/147

(57) ABSTRACT

A dampening fluid metering system includes an anilox roll configured to meter dampening fluid onto a surface of an imaging member to form a thin, uniform layer of dampening fluid for subsequent imaging by exposure to light radiation. The anilox roll is configured to form a dampening fluid layer that is uniform and has a thickness of 1 micron or less, and preferably a thickness lying in a range of 0.2 to 1 micron.

### FIELD OF DISCLOSURE

The disclosure relates to ink-based digital printing. In particular, this disclosure relates to systems for applying dampening fluid to a surface of a reimageable imaging member for ink-based digital printing.

### BACKGROUND

Ink-based digital printing systems are variable data lithography systems configured for digital lithographic printing that may include an imaging member having a reimageable surface layer, such as a silicone containing surface layer. Systems may include a dampening fluid metering system for applying dampening fluid to the reimageable surface layer, and an imaging system for laser patterning the layer of dampening fluid according to image data. The dampening fluid layer is patterned by the imaging system to form a dampening fluid pattern on a surface of the imaging member based on variable data. The imaging member is then inked to form an ink image based on the dampening fluid pattern. The ink image may be partially cured, and is transferred to a printable medium, and the imaged surface of the imaging member from which the ink image is transferred is cleaned for forming a further image that may be different than the initial image, or based on different image data than the image data used to form the first image. Such systems are disclosed in U.S. patent application Ser. No. 13/095,714 (“714 application”), titled “Variable Data Lithography System,” filed on Apr. 27, 2011 by Stowe et al., which is commonly assigned, and the disclosure of which is hereby incorporated by reference herein in its entirety. The systems and methods disclosed in the 714 application are directed to improvements on various aspects of previously-attempted variable data imaging lithographic marking concepts based on variable patterning of dampening fluids to achieve effective truly variable digital data lithographic printing.

### SUMMARY

Related art systems have been found to accommodate limited control over dampening fluid layer thickness, and eliminating dampening fluid layer instabilities that result in print streak defects. Systems are provided that implement an anilox roll for applying a uniform layer of dampening fluid during digital ink-based printing processes. In an embodiment, systems may include a dampening fluid metering system having an anilox roll configured to meter dampening fluid for forming a dampening fluid layer having a uniform thickness lying in a range of 0.2 to 1 micron on a surface of an imaging member. Systems may include a metering roll configured to meter dampening fluid onto a surface of the anilox roll.

In an embodiment, the metering roll and the anilox roll may be configured to define a dampening fluid transfer nip. Systems may include a dampening fluid reservoir formed at the nip, the reservoir being formed by the metering roll and the anilox roll during transfer of dampening fluid to the anilox roll. Systems may include a heating system for heating the dampening fluid before metering the dampening fluid onto the imaging member, wherein the heating adjusts a viscosity of the dampening fluid. Systems may include a doctor blade, the doctor blade being configured to remove excess dampening from a surface of the anilox roll during metering dampening fluid onto the surface of the imaging member. Systems may include an imaging member having a re-imageable surface containing silicone, the imaging member being an imaging plate disposed on a rotatable cylinder.

In another embodiment, systems may include a doctor blade configured to meter dampening fluid onto a surface of the anilox roll. Systems may include a metering roll configured to meter dampening fluid onto the surface of the imaging member, the anilox roll being configured to meter dampening fluid onto a surface of the metering roll. Systems may include a dampening fluid supply device configured to deposit dampening fluid into the surface of the imaging member, the anilox roll being configured to apply an anilox roll force against the surface of the imaging member for the forming the dampening fluid layer.

In an embodiment, ink-based digital printing systems may have a dampening system with an anilox roll for forming thin a uniform layer of dampening fluid on a surface of an imaging member. Systems may include a dampening fluid metering system, the system having an anilox roll; and an imaging member, the imaging member being configured to receive dampening fluid supplied form the dampening fluid metering system. Systems may include a metering roll, the metering roll being configured to receive dampening fluid from the anilox roll, the anilox roll being configured for applying an anilox roll force against the metering roll at a nip formed by the metering roll and the anilox roll, the metering roll being configured to apply a metering roll force against the surface of the imaging member for squeezing dampening fluid between the imaging member and the metering roll to form a uniform layer of dampening fluid.

In an embodiment, the uniform layer of dampening fluid may have a thickness of 0.2 microns to 1 micron. In an embodiment, the uniform layer of dampening fluid may have a thickness of 1 micron or less. In an embodiment, the uniform layer of dampening fluid may have a thickness of less than 1 micron.

In an embodiment, systems may include a metering roll, the metering roll being configured to meter dampening fluid on the anilox roll, the metering roll being configured to apply a metering roll force against the anilox roll, the anilox roll being configured to apply an anilox roll force against the surface of the imaging member for squeezing dampening fluid between the imaging member and the anilox roll to form a uniform layer of dampening fluid. In an embodiment, at least one of the anilox roll force and the metering roll force being adjustable.

Exemplary embodiments are described herein. It is envisioned, however, that any system that incorporates features of systems described herein are encompassed by the scope and spirit of the exemplary embodiments.

### BRIEF DESCRIPTION OF THE DRAWINGS

FIG. 1 shows a side diagrammatical view of a related art ink-based digital printing system;

FIG. 2 shows a photomicrograph of anilox roll cells on a surface of an anilox roll;

FIG. 3 shows a dampening fluid metering system in accordance with an exemplary embodiment;

FIG. 4 shows a dampening fluid metering system in accordance with an exemplary embodiment;

FIG. 5 shows a dampening fluid metering system in accordance with an exemplary embodiment;

FIG. 6 shows a dampening fluid metering system in accordance with an exemplary embodiment.

### DETAILED DESCRIPTION

Exemplary embodiments are intended to cover all alternatives, modifications, and equivalents as may be included within the spirit and scope of the apparatus and systems as described herein.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value.

Reference is made to the drawings to accommodate understanding of systems for ink-based digital printing system using a dampening fluid metering system having an anilox roll. In the drawings, like reference numerals are used throughout to designate similar or identical elements. The drawings depict various embodiments of illustrative systems of ink-based digital printing using a dampening fluid metering system having an anilox roll for enhanced control over dampening fluid layer thickness for image formation on an imaging member.

The 714 application describes an exemplary variable data lithography system 100 for ink-based digital printing, such as that shown, for example, in FIG. 1. A general description of the exemplary system 100 shown in FIG. 1 is provided here. Additional details regarding individual components and/or subsystems shown in the exemplary system 100 of FIG. 1 may be found in the 714 application.

As shown in FIG. 1, the exemplary system 100 may include an imaging member 110. The imaging member 110 in the embodiment shown in FIG. 1 is a drum, but this exemplary depiction should not be interpreted so as to exclude embodiments wherein the imaging member 110 includes a drum, plate or a belt, or another now known or later developed configuration. The reimageable surface may be formed of materials including, for example, a class of materials commonly referred to as silicones, including polydimethylsiloxane (PDMS), among others. The reimageable surface may be formed of a relatively thin layer over a mounting layer, a thickness of the relatively thin layer being selected to balance printing or marking performance, durability and manufacturability.

The imaging member 110 is used to apply an ink image to an image receiving media substrate 114 at a transfer nip 112. The transfer nip 112 is formed by an impression roller 118, as part of an image transfer mechanism 160, exerting pressure in the direction of the imaging member 110. Image receiving medium substrate 114 should not be considered to be limited to any particular composition such as, for example, paper, plastic, or composite sheet film. The exemplary system 100 may be used for producing images on a wide variety of image receiving media substrates. The 714 application also explains the wide latitude of marking (printing) materials that may be used, including marking materials with pigment densities greater than 10% by weight. As does the 714 application, this disclosure will use the term ink to refer to a broad range of printing or marking materials to include those which are commonly understood to be inks, pigments, and other materials which may be applied by the exemplary system 100 to produce an output image on the image receiving media substrate 114.

The 714 application depicts and describes details of the imaging member 110 including the imaging member 110 being comprised of a reimageable surface layer formed over a structural mounting layer that may be, for example, a cylindrical core, or one or more structural layers over a cylindrical core.

The exemplary system 100 includes a dampening fluid system 120 generally comprising a series of rollers, which may be considered as dampening rollers or a dampening unit, for uniformly wetting the reimageable surface of the imaging member 110 with dampening fluid. A purpose of the dampening fluid system 120 is to deliver a layer of dampening fluid, generally having a uniform and controlled thickness, to the reimageable surface of the imaging member 110. As indicated above, it is known that a dampening fluid such as fountain solution may comprise mainly water optionally with small amounts of isopropyl alcohol or ethanol added to reduce surface tension as well as to lower evaporation energy necessary to support subsequent laser patterning, as will be described in greater detail below. Small amounts of certain surfactants may be added to the fountain solution as well. Alternatively, other suitable dampening fluids may be used to enhance the performance of ink based digital lithography systems. Exemplary dampening fluids include water, Novec 7600 (1,1,1,2,3,3-Hexafluoro-4-(1,1,2,3,3,3-hexafluoropropoxy)pentane and has CAS#870778-34-0.), and D4 (octamethylcyclotetrasiloxane). Other suitable dampening fluids are disclosed, by way of example, in co-pending U.S. patent application Ser. No. 13/284,114, filed on Oct. 28, 2011, titled DAMPENING FLUID FOR DIGITAL LITHOGRAPHIC PRINTING, the disclosure of which is hereby incorporated herein by reference in its entirety.

Once the dampening fluid is metered onto the reimageable surface of the imaging member 110, a thickness of the dampening fluid may be measured using a sensor 125 that may provide feedback to control the metering of the dampening fluid onto the reimageable surface of the imaging member 110 by the dampening fluid system 120.

After a precise and uniform amount of dampening fluid is provided by the dampening fluid system 120 on the reimageable surface of the imaging member 110, and optical patterning subsystem 130 may be used to selectively form a latent image in the uniform dampening fluid layer by image-wise patterning the dampening fluid layer using, for example, laser energy. Typically, the dampening fluid will not absorb the optical energy (IR or visible) efficiently. The reimageable surface of the imaging member 110 should ideally absorb most of the laser energy (visible or invisible such as IR) emitted from the optical patterning subsystem 130 close to the surface to minimize energy wasted in heating the dampening fluid and to minimize lateral spreading of heat in order to maintain a high spatial resolution capability. Alternatively, an appropriate radiation sensitive component may be added to the dampening fluid to aid in the absorption of the incident radiant laser energy. While the optical patterning subsystem 130 is described above as being a laser emitter, it should be understood that a variety of different systems may be used to deliver the optical energy to pattern the dampening fluid.

The mechanics at work in the patterning process undertaken by the optical patterning subsystem 130 of the exemplary system 100 are described in detail with reference to FIG. 5 in the 714 application. Briefly, the application of optical patterning energy from the optical patterning subsystem 130 results in selective removal of portions of the layer of dampening fluid.

Following patterning of the dampening fluid layer by the optical patterning subsystem 130, the patterned layer over the reimageable surface of the imaging member 110 is presented to an inker subsystem 140. The inker subsystem 140 is used to apply a uniform layer of ink over the layer of dampening fluid and the reimageable surface layer of the imaging member 110. The inker subsystem 140 may use an anilox roller to meter an offset lithographic ink onto one or more ink forming rollers that are in contact with the reimageable surface layer of the imaging member 110. Separately, the inker subsystem 140 may include other traditional elements such as a series of metering rollers to provide a precise feed rate of ink to the reimageable surface. The inker subsystem 140 may deposit the ink to the pockets representing the imaged portions of the reimageable surface, while ink on the unformatted portions of the dampening fluid will not adhere to those portions.

The cohesiveness and viscosity of the ink residing in the reimageable layer of the imaging member 110 may be modified by a number of mechanisms. One such mechanism may involve the use of a rheology (complex viscoelastic modulus) control subsystem 150. The rheology control system 150 may form a partial crosslinking core of the ink on the reimageable surface to, for example, increase ink cohesive strength relative to the reimageable surface layer. Curing mechanisms may include optical or photo curing, heat curing, drying, or various forms of chemical curing. Cooling may be used to modify rheology as well via multiple physical cooling mechanisms, as well as via chemical cooling.

The ink is then transferred from the reimageable surface of the imaging member 110 to a substrate of image receiving medium 114 using a transfer subsystem 160. The transfer occurs as the substrate 114 is passed through a nip 112 between the imaging member 110 and an impression roller 118 such that the ink within the voids of the reimageable surface of the imaging member 110 is brought into physical contact with the substrate 114. With the adhesion of the ink having been modified by the rheology control system 150, modified adhesion of the ink causes the ink to adhere to the substrate 114 and to separate from the reimageable surface of the imaging member 110. Careful control of the temperature and pressure conditions at the transfer nip 112 may allow transfer efficiencies for the ink from the reimageable surface of the imaging member 110 to the substrate 114 to exceed 95%. While it is possible that some dampening fluid may also wet substrate 114, the volume of such a dampening fluid will be minimal, and will rapidly evaporate or be absorbed by the substrate 114.

In certain offset lithographic systems, it should be recognized that an offset roller, not shown in FIG. 1, may first receive the ink image pattern and then transfer the ink image pattern to a substrate according to a known indirect transfer method.

Following the transfer of the majority of the ink to the substrate 114, any residual ink and/or residual dampening fluid must be removed from the reimageable surface of the imaging member 110, preferably without scraping or wearing that surface. An air knife may be employed to remove residual dampening fluid. It is anticipated, however, that some amount of ink residue may remain. Removal of such remaining ink residue may be accomplished through use of some form of cleaning subsystem 170. The 714 application describes details of such a cleaning subsystem 170 including at least a first cleaning member such as a sticky or tacky member in physical contact with the reimageable surface of the imaging member 110, the sticky or tacky member removing residual ink and any remaining small amounts of surfactant compounds from the dampening fluid of the reimageable surface of the imaging member 110. The sticky or tacky member may then be brought into contact with a smooth roller to which residual ink may be transferred from the sticky or tacky member, the ink being subsequently stripped from the smooth roller by, for example, a doctor blade.

The 714 application details other mechanisms by which cleaning of the reimageable surface of the imaging member 110 may be facilitated. Regardless of the cleaning mechanism, however, cleaning of the residual ink and dampening fluid from the reimageable surface of the imaging member 110 is essential to preventing ghosting in the proposed system. Once cleaned, the reimageable surface of the imaging member 110 is again presented to the dampening fluid system 120 by which a fresh layer of dampening fluid is supplied to the reimageable surface of the imaging member 110, and the process is repeated.

Dampening fluid such as D4 or fountain solution may be used to prevent ink from developing onto a background area of an image formed on an imaging member. The dampening fluid layer must be very thin and uniform before being exposed to radiation at a laser imaging step, for example. In particular, the dampening fluid layer should be about 1 micron thick. The fluid must be thin enough so as not to require significant laser power and impact productivity, and prevent image quality defects by minimizing pullback due to fluid edge movements, wash-out of edges due to displacement of fluid under pressure applied at an inking or transfer nip. If the dampening fluid layer is too thin, then background problems with the image may arise.

Applying a desired amount of dampening fluid to an imaging member surface is critical for printing process control and image quality latitudes such as halftone uniformity, tone reproduction curve, plate aging, etc. Dampening fluid layer thickness and uniformity must be accurately controllable, e.g., by <0.02 micron steps, over a wide range with quick actuation.

Flow coating technologies for applying a material to a surface are known for various fluids, substrates, and thicknesses. There are very few, however, known flow coating technologies that can produce a uniform sub-micron (0.2 to about 1 micron) coating using materials that have rheological properties similar to dampening fluids such as Novec fountain solution, or D4 having a viscosity in a range of 1 cP to about 5 cP.

Anilox roll coating, or gravure coating, has been found to be useful for controlled application of a uniform layer of dampening fluid having a thickness that is 1 micron, or less than 1 micron. Many flow coating technologies have been found to be unsuitable for applying dampening fluid without coating defects or non-uniformities because the layer thickness cannot be adjusted easily, quickly, or over a wide range. Anilox roll coatings offer a selection of rolls and coating volumes that can provide coarse adjustment of fluid application and layer formation. Fine adjustment may be achieved using metering methods.

Accurate control over dampening fluid layer thickness and uniformity is critical to image quality of ink images and system productivity. Related art flow coating technologies cannot deliver a uniform coating of dampening fluid at a desired thickness. In addition, control over dampening fluid layer thickness over a wide range without comprising uniformity is challenging. Related art dampening fluid delivery systems do not satisfy the dampening fluid dampening fluid layer requirements for ink-based digital or variable data printing. For example, blade metering systems have been implemented for enabling control over dampening fluid layer thickness and uniformity, but such systems demonstrate little control over layer thickness and uniformity, and do not adequately prevent or eliminate instabilities in the fluid layer that cause print streak defects.

An anilox or gravure-type roll is typically used in flexographic printing as an inking roll. An anilox roll coating or gravure coating define millions of etched or engraved microscopic cells. A pictomicrograph of anilox roll surface is shown in FIG. 2. The cells may be filled with fluid and metered with a blade or roller to deliver a precise amount of fluid to a receiving surface. Systems and methods for uniform metering of dampening fluid onto an imaging member for ink-based digital printing are provided. Systems and methods enable uniform metering of dampening fluid for forming a dampening fluid layer on an imaging member surface, the layer having a desired thickness. Preferably the dampening fluid metering system having anilox roll enables forming a dampening fluid layer having a thickness lying in range of about 1 micron to 0.2 micron.

FIG. 3 shows a preferred embodiment of an ink-based digital printing system having a dampening fluid metering system with an anilox roll. In particular, digital printing system 300 includes an imaging member 301. The imaging member 301 may be a silicone-containing plate capable of absorbing light. The plate may be wrapped around a cylinder that rotates in a direction A, a process direction.

An anilox roll 307 of a dampening fluid metering system is arranged adjacent to the imaging member 301 and configured for applying a downward force against the imaging plate and interposing dampening fluid. In particular, a dampening fluid supply device 315 deposits dampening fluid 321, e.g., fountain solution as shown in FIG. 3, to a surface of the imaging member 30. The dampening fluid 321 is deposited upstream, e.g., 15 to 20 mm, of the anilox roll 307. The anilox roll 307 is caused to apply a downward anilox roll application force (Fₐₙᵢₗₒₓ) against dampening fluid 321 and the imaging member 301, forming a uniform layer having a thickness suitable for ink-based digital printing. In some embodiments, a flow rate of the dampening fluid supply device 315 may be controlled based on feedback data from a monitoring system configured to monitor an amount of dampening fluid 321 build-up at an entrance, with respect to a process direction, of the metering nip defined by the anilox roll 307 and the imaging member 301. The thickness of the dampening fluid layer 325 formed by the application of force against the dampening fluid 321 and the imaging member 301 may be controlled by adjusting an amount of application force Fₐₙᵢₗₒₓ applied during dampening fluid metering.

FIG. 4 shows another embodiment of a dampening fluid metering system 400 having an anilox roll. In particular, FIG. 4 shows a dampening fluid metering system 400 having an anilox roll 407. The system 400 is configured to be arranged with respect to an imaging member so that the anilox roll 407 can apply pressure to the imaging plate and interposing dampening fluid to form a uniform dampening fluid layer having a thickness of 1 micron or less, and preferably 0.2 to 1 micron.

The system 400 includes a metering roll 417 configured to contact the anilox roll 407 for removing excess dampening fluid from a surface of the anilox roll 407. Accordingly, the metering roll 417 may be configured for metering dampening fluid on the anilox roll 407 surface prior to contact with the imaging member of the printing system. Advantageously, a small reservoir of dampening fluid may be formed and maintained at a region of the nip formed by the metering roll 417 and the anilox roll 407. The force between the metering roll 417 and the anilox roll 407 provide an additional parameter for adjusting dampening fluid thickness. A doctor blade or similar device may be implemented instead of metering roll 417 for metering dampening fluid on the surface of the anilox roll 407.

In some embodiments, a doctor blade may be used. For example, FIG. 5 shows another embodiment of a dampening fluid metering system 500 having an anilox roll. In particular, FIG. 5 shows a dampening fluid metering system 500 having an anilox roll 507. The system 500 is configured to be arranged with respect to an imaging member so that the anilox roll 507 can apply pressure to the imaging plate and interposing dampening fluid to form a uniform dampening fluid layer having a thickness of 1 micron or less, and preferably 0.2 to 1 micron.

FIG. 5 shows a reverse doctor blade configuration including a doctor blade 531 configured to meter dampening fluid on the surface of the anilox roll 507. A reservoir of dampening fluid may be advantageously formed and maintained by the doctor blade 531 and the anilox roll 507.

In another embodiment, a dampening fluid system may include anilox roll configured to meter dampening fluid onto a metering roll that contacts a surface of an imaging member for forming a dampening fluid layer thereon. For example, FIG. 6 shows a printing system 600 including an imaging member 601. A dampening fluid metering system is disposed adjacent to the imaging member 601, which is configured to translate in a process direction A.

The dampening fluid metering system includes and anilox roll 607. The anilox roll 607 is configured to form a dampening fluid transfer nip with a dampening fluid metering roll 617. The anilox roll 607 is configured to apply a F_{metering roll} force against the metering roll 617 to meter dampening fluid onto the metering roll 617. The metering roll 617 may be configured to contact a surface of the imaging member 601, and may be configured to apply a F_{metering roll} force against the imaging member 601 surface while contacting dampening fluid metered to the metering roll 617 surface by the anilox roll 607. Accordingly, a uniform dampening fluid layer 625 having a thickness of 0.2 to 1 micron may be formed. A thickness of the dampening fluid layer 625 may be controlled by adjusting the metering roll and anilox roll forces.

While FIG. 6 shows fountain solution, other dampening fluids may used. Preferably, D4 may be used. A thickness of the dampening fluid layer may be controlled by controlling a temperature of the dampening fluid to adjust a viscosity thereof. Temperature control may be implemented in any of the embodiments.

It will be appreciated that the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. A dampening fluid metering system, comprising:
an anilox roll configured to meter dampening fluid for forming a dampening fluid layer having a uniform thickness lying in a range of 0.2 to 1 micron on a surface of an imaging member.

2. The system of claim 1, comprising:
a metering roll configured to meter dampening fluid onto a surface of the anilox roll.

3. The system of claim 2, the metering roll and the anilox roll defining a dampening fluid transfer nip, the system comprising:
a dampening fluid reservoir formed at the nip, the reservoir being formed by the metering roll and the anilox roll during transfer of dampening fluid to the anilox roll.

4. The system of claim 1, comprising:
a heating system for heating the dampening fluid before metering the dampening fluid onto the imaging member, wherein the heating adjusts a viscosity of the dampening fluid.

5. The system of claim 1, comprising:
a doctor blade, the doctor blade being configured to remove excess dampening from a surface of the anilox roll during metering dampening fluid onto the surface of the imaging member.

6. The system of claim 5, the angle between the doctor blade and the anilox roll being adjustable for metering a desired amount of dampening fluid.

7. The system of claim 1, comprising:
an imaging member having a re-imageable surface containing silicone, the imaging member being an imaging plate disposed on a rotatable cylinder.

8. The system of claim 1, comprising:
a metering roll configured to meter dampening fluid onto the surface of the imaging member, the anilox roll being configured to meter dampening fluid onto a surface of the metering roll.

9. The system of claim 1, comprising:
a dampening fluid supply device configured to deposit dampening fluid into the surface of the imaging member, the anilox roll being configured to apply an anilox roll force against the surface of the imaging member for the forming the dampening fluid layer.

10. An ink-based digital printing system having a dampening system with an anilox roll for forming thin a uniform layer of dampening fluid on a surface of an imaging member, comprising:
a dampening fluid metering system, the system having an anilox roll; and
an imaging member, the imaging member being configured to receive dampening fluid supplied form the dampening fluid metering system.

11. The system of claim 10, the dampening fluid metering system further comprising:
a metering roll, the metering roll being configured to receive dampening fluid from the anilox roll, the anilox roll being configured for applying an anilox roll force against the metering roll at a nip formed by the metering roll and the anilox roll, the metering roll being configured to apply a metering roll force against the surface of the imaging member for squeezing dampening fluid between the imaging member and the metering roll to form a uniform layer of dampening fluid.

12. The system of claim 11, the uniform layer of dampening fluid having a thickness of 0.2 to 1 micron.

13. The system of claim 11, the uniform layer of dampening fluid having a thickness of 1 micron or less.

14. The system of claim 11, the uniform layer of dampening fluid having a thickness of less than 1 micron.

15. The system of claim 10, the dampening fluid metering system further comprising:
a metering roll, the metering roll being configured to meter dampening fluid on the anilox roll, the metering roll being configured to apply a metering roll force against the anilox roll, the anilox roll being configured to apply an anilox roll force against the surface of the imaging member for squeezing dampening fluid between the imaging member and the anilox roll to form a uniform layer of dampening fluid.

16. The system of claim 15, the uniform layer of dampening fluid having a thickness of 0.2 to 1 micron.

17. The system of claim 15, the uniform layer of dampening fluid having a thickness of 1 micron or less.

18. The system of claim 15, the uniform layer of dampening fluid having a thickness of less than 1 micron.

19. The system of claim 11, at least one of the anilox roll force and the metering roll force being adjustable.

20. The system of claim 15, at least one of the metering roll force and anilox roll force being adjustable.
